(19) United States
(12) Patent Application Publication
(10) Pub. No.: US 2017/0270476 A1
(43) Pub. Date: Sep. 21, 2017

(54) METHOD OF TRANSPORT OF AN OBJECT

(71) Applicant: PA.COTTE SA, Pully (CH)

(72) Inventor: Pierre-Alain COTTE, Amberg (DE)

(21) Appl. No.: 15/461,077

(22) Filed: Mar. 16, 2017

(30) Foreign Application Priority Data
Mar. 16, 2016 (FR) 1652238

(51) Int. Cl. G06Q 10/08; H04W 4/00

(52) U.S. Cl. CPC G06Q 10/0831; H04W 4/008

(57) ABSTRACT

A method for managing transport of an item includes the steps of:
receiving a delivery request of an item;
calculating an optimised itinerary of the item;
defining the position of a first custodian individual and of a second custodian individual;
linking the item to a packet;
receiving a first validation delivery datum when the item is handed over to the first custodian individual;
receiving a second validation delivery datum when the packet is handed over to a main transporter individual;
receiving a third validation delivery datum when the packet is handed over to the second custodian individual;
receiving a fourth validation delivery datum when the item is handed over to the recipient client individual.

### CROSS REFERENCE TO RELATED APPLICATION

The present application claims priority to French Patent Application Number 1652238 filed on Mar. 16, 2016, entitled “METHOD OF TRANSPORT OF AN OBJECT”, the entire disclosure of which is incorporated herein by reference.

### FIELD OF THE INVENTION

The invention relates to the field of transport and delivery of items.

### BACKGROUND OF THE INVENTION

Electronic commerce professionals, parcel transport companies and courier companies are noticing an important development and posting increasingly good delivery performances, especially in terms of transport time and rate.

But these delivery performances should be qualified for a certain number of reasons.

It is evident first of all that these different players in the transport and delivery of parcels boast very fast deliveries only very rarely, at a reasonable rate and over a relatively long distance. So, electronic commerce professionals generally propose no delivery with a delivery time of less than one working day. Similarly, rates of courier companies are attractive only when the origin and destination of the delivery are in the same town or in the same region.

It is also noted that delivery performances are effectively significant when they are national deliveries, but much less so when they are international deliveries. International parcel transport constitutes a niche market involving a relatively reduced number of parcel transport companies, and in which delivery performances are relatively limited.

Low performance in international deliveries is due especially to highly centralised management of these international deliveries. Parcel transport companies combine parcels in a country of origin, carry out “bulk” grouped transport to a country of destination, combine parcels in the country of destination, and finally deliver parcels to their clients in the country of destination. International deliveries need substantial resources: human resources, transport means (some big international transport companies have their own aircraft fleet), storage depots, etc. The complexity of managing these resources largely explains low delivery performance for international parcel transport.

It is finally noted that in general only delivery performances in terms of transport time and rate are taken into account by the different players in transport and delivery of parcels. Yet some clients are at least also interested by other types of delivery performances. Some clients are interested by performance relative to transport conditions: levels of shocks undergone during transport, temperature in the environment of the parcel during transport, etc. Other clients emphasise security of delivery, and would want for example to be warned in real time of the opening of their parcel. Other clients would want to be able to know the precise position of their parcel in real time.

### AIM OF THE INVENTION

An aim of the invention is to improve the abovementioned delivery performances at least in part.

### SUMMARY OF THE INVENTION

For this reason, according to the invention a method for managing transport of an item executed by an IT platform is provided, comprising the steps of:
receiving a delivery request of an item sent by a sending client individual;
   calculating an optimised itinerary of the item between a position of the sending client individual and a position of a recipient client individual;
defining the position of a first custodian individual and a second custodian individual;
linking the item to a packet in which the item is introduced, the packet comprising an electric module comprising a wireless proximity communications device;
receiving a first validation delivery datum when the item or the packet containing the item is handed over to the first custodian individual;
receiving a second validation delivery datum when the packet is handed over to a main transporter individual by the first custodian individual;
receiving a third validation delivery datum when the packet is handed over to the second custodian individual by the main transporter individual;
receiving a fourth validation delivery datum when the item or the packet containing the item is handed over to the recipient client individual.

Executing the method for managing transport of an item according to the invention involves successively a plurality of individuals. Transport of the item therefore comprises no centralised management step, reducing both time and cost of this transport.

The main transporter individual can easily have planned the route between the position of the first custodian individual and the position of the second custodian individual for reasons other than that of transport of the item. This therefore reduces the total cost of the transport of the item, since in this case it is not necessary to provide a dedicated resource to take this route.

It is also noted that receipt of delivery validation data verifies the correct handing over of the item or the packet containing the item to the different individuals involved in the transport of the item, improving security and traceability of the item during transport.

It is noted finally that the wireless proximity communications device of the packet containing the item enables transmission from the packet of various data (for example various measurements made by sensors integrated into the packet itself) to the sending client individual and to the recipient client individual (via the IT platform).

Other characteristics and advantages of the invention will emerge from the following description of a particular non-limiting embodiment of the invention.

### BRIEF DESCRIPTION OF THE DRAWINGS

Reference is made to the appended drawings, wherein:

FIG. 1 schematically illustrates the packet used in the method for managing transport of an item according to the invention;

FIGS. 2 to 5 illustrate pages displayed on electronic devices by an IT application prior to executing the method for managing transport of an item according to the invention;

FIG. 6 schematically illustrates the relationships between the individuals involved in a first example of executing the method for managing transport of an item according to the invention;

FIGS. 7 to 14 illustrate pages displayed on electronic devices by the IT application during the first example of executing the method for managing transport of an item according to the invention;

FIG. 15 schematically illustrates the relationships between the individuals involved in a second example of executing the method for managing transport of an item according to the invention.

### DETAILED DESCRIPTION OF THE INVENTION

The method for managing transport of an item according to the invention is intended to manage the transport and delivery of an item between a position of origin where a sending client individual of the item is and a destination position where a recipient client individual of the item is.

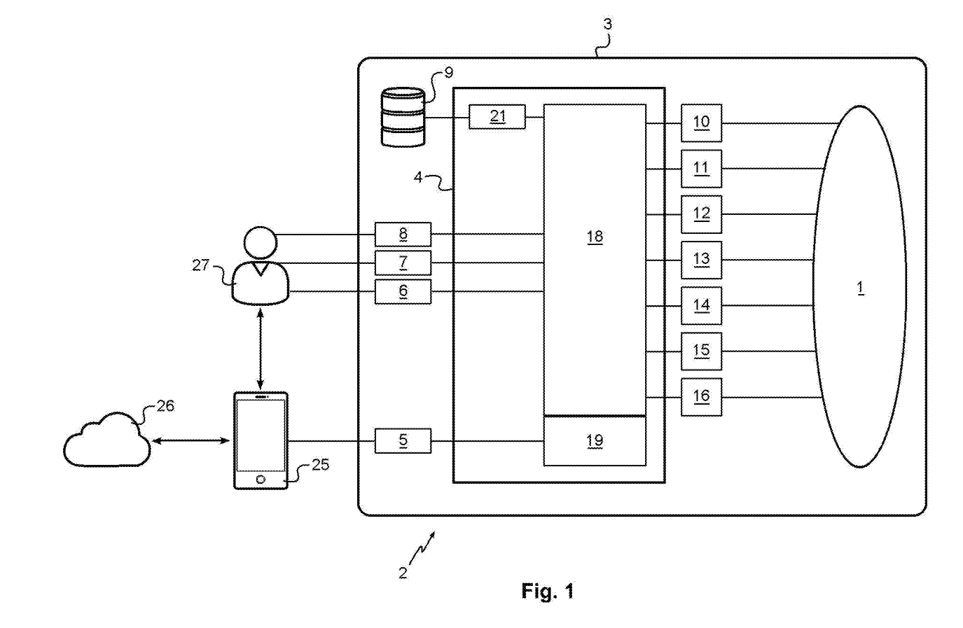

In reference to FIG. 1, the item 1 in question here is an item of any type. It is preferable (though not obligatory) that the weight and dimensions of the item 1 allow an individual to transport the item 1 by hand. The item 1 can for example be a file, an electronic device any, a book, a garment, a jewel, artwork, etc.

The sending client individual of the item 1 is an individual in possession of the item 1 prior to transport of the item 1. The recipient client individual of the item 1 is an individual who receives the item 1 during its final delivery following transport of the item 1. The relationship between the sending client individual and the recipient client individual at the origin of transport is any kind of relation, private or professional.

The transport management method according to the invention is executed by an IT platform. Executing the transport management method according to the invention involves a certain number of resources to be defined.

Carrying out the transport management method according to the invention first involves a packet 2.

The packet 2 comprises an envelope 3, rigid or not, able to be opened by all those individuals to be mentioned in this description. The envelope 3 of the packet 2 has a sufficiently large internal volume to fit the item 1. The envelope 3 is also provided with means enabling its opening and closing by each of the individuals. These means comprise for example self-fastening strips (for example the VELCRO brand) or repositionable adhesives bordering an opening of the envelope 3. It is possible also to provide, in particular on a rigid envelope, a lock actionable via a code contained in a mobile communications terminal.

Advantageously (but not necessarily), the packet 2 is adapted to the criteria defined by airline companies for the carry-on baggage.

Apart from the envelope 3, the packet 2 comprises an electric module 4 and many components, including an antenna 5, a buzzer 6, a LED 7, a push button 8, a battery 9, a movement and shock sensor 10, a temperature sensor 11, a humidity sensor 12, a weight sensor 13, detection means 14, a flash generator 15 and a camera 16.

The electric module 4 comprises a microcontroller 18, a wireless proximity communications device comprising a Bluetooth module 19 (the microcontroller 18 and the Bluetooth module 19 can be integrated within the same component), a memory 20, and a power management module 21. The Bluetooth module 19 is connected to the antenna 5 (which can be integrated into the Bluetooth module 19).

The components of the many components are connected to the microcontroller 18.

The microcontroller 18 manages the operation of the electric module 4 and of the many components.

The microcontroller 18 especially manages incoming and outgoing communications via the Bluetooth module 19, controls the buzzer 6 and the LED 7, acquires the measuring data produced by the sensors 10, 11, 12, 13 and the detection means 14, acquire the images produced by the camera 16, control the flash generator 15, etc.

The push button 8 activates or deactivates the electric module 4 and the many components.

The buzzer 6 and the LED 7 (situated on an external surface of the envelope 3) are respectively intended to send a sound signal and a visual signal to signal the position of the packet 2.

The battery 9 feeds the electric module 4 and the many components via the power management module 21.

The movement and shock sensor 10 measures the shocks and movements undergone by the packet 2 and therefore by the item 1. The temperature sensor 11 measures the temperature inside the packet 2. The humidity sensor 12 measures the humidity inside the packet 2. The weight sensor 13 weighs the item 1 when it is positioned in the packet 2. The detection means 14 detect opening and closing of the packet 2. The flash generator 15 generates a flash inside the packet 2 to let the camera 16 film the interior of the packet 2.

Executing the transport management method according to the invention also involves a plurality of electronic devices such as the electronic device 25. The plurality of electronic devices 25 comprises mobile communications terminals and for example a smartphone, a table, a portable computer, a connected clock, etc. The electronic devices 25 are adapted to communicate with each packet 2 via the Bluetooth module 19 of the packet 2.

Executing the transport management method according to the invention also involves a plurality of various interconnected IT resources (servers, etc.) to form a virtual or cloud IT network 26. The various IT resources comprise the IT platform (in turn comprising preferably a remotely accessible server) which performs the various steps of the transport management method according to the invention.

Executing the transport method according to the invention also involves an IT application. The IT platform executes the IT application. The IT application is installed and loaded onto each electronic device 25. Each electronic device 25 is connected to the cloud 26 and to the IT platform via the IT application and via long-distance communication means housed in each electronic device 25. Each packet 2 can communicate with the IT platform via an electronic device 25 (and the long-distance communication means of this electronic device 25).

Executing the transport management method according to the invention finally involves human resources 27, distributed over three categories: client individuals, transporter individuals and custodian individuals. These individuals are combined into a community which runs a transport and delivery system of collaborative type.

The client individuals are individuals who benefit from a delivery service utilising the transport management method according to the invention. The client individuals comprise the sending client individual of the item 1 and the recipient client individual of the item 1, as above.

The transporter individuals transport the item 1 on behalf of the client individuals. Advantageously, the transporter individuals take the route corresponding to transport for another reason (professional, personal, etc.), and profit from this route to transport the item 1.

The custodian individuals are positioned in the immediate proximity to points of departure or arrival of various transport means: airports, railway stations, bus terminals, wharves, etc. Advantageously, the custodian individuals are positioned in a place comprising a storage surface for storing packets 2. In this way, the custodian individuals are usually located in a boutique such as a cafe, a restaurant, a tobacco shop, etc.

The role of custodian individuals is first to recover items 1 brought by transporter individuals or client individuals, introduce each item 1 to a packet 2, and store the packets 2 (and the items 1). The items 1 are possibly (but not necessarily) already contained in packets 2 when brought to the custodian individuals. If this is not the case, the custodian individuals themselves introduce the items 1 to packets 2. The custodian individuals must therefore permanently keep empty packets 2. Storage of a packet 2, whereof the duration can vary from a few seconds to a few days, is accomplished when a transporter individual or a client individual comes to pick up the packet 2.

Each custodian individual therefore plays the role of a buffer between two individuals in the transport of an item 1 and a packet 2.

Each client, transporter or custodian individual, must be registered via the IT application previously loaded onto an electronic device 25 in possession of said client, transporter or custodian individual. Each client, transporter or custodian individual likely to be involved in carrying out the transport management method according to the invention has, in the IT application, a profile which lets him access a personal space and personal web site.

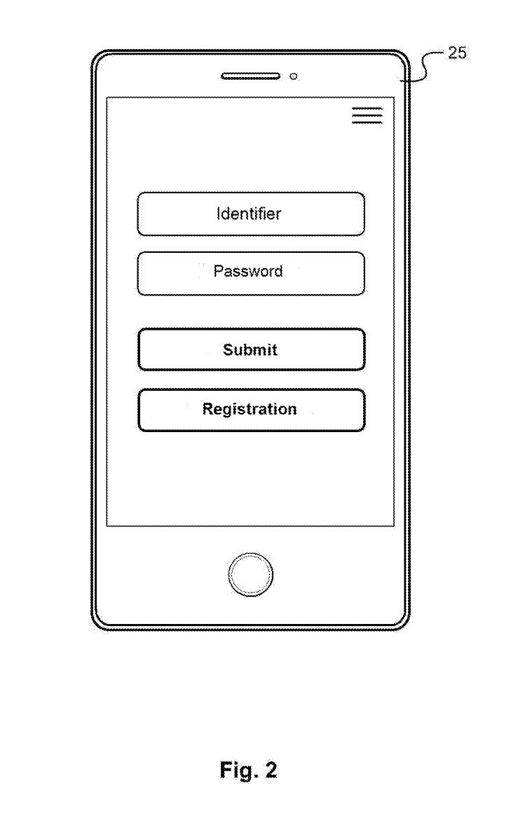

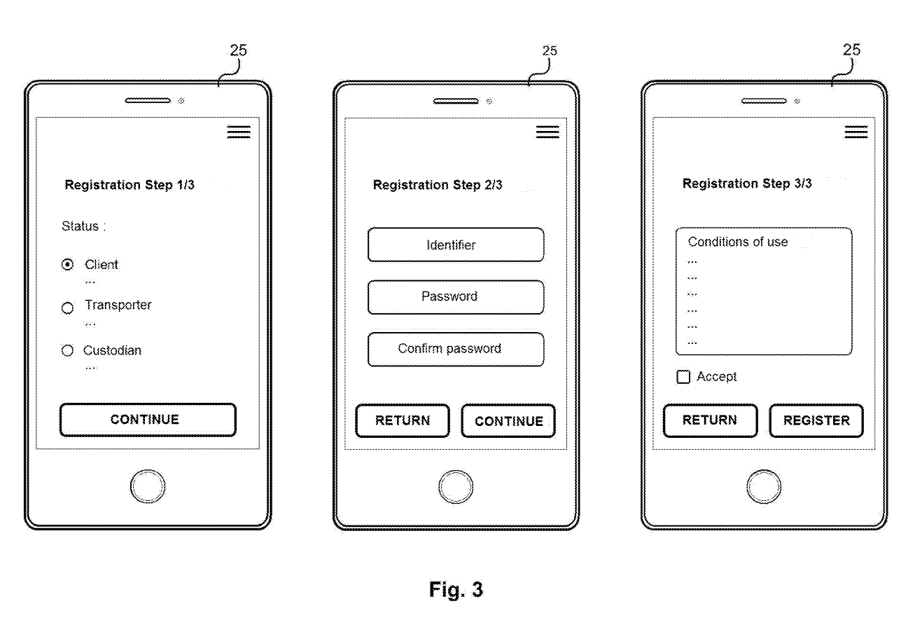

So after having loaded the IT application onto an electronic device 25 in his possession, a client individual opens the IT application on his electronic device 25. A welcome page (seen in FIG. 2) appears. The welcome page is followed by login pages (seen in FIG. 3). The client individual inputs an identifier and a password and logs in as a client.

Similarly, a transporter individual logs in as a transporter, and the custodian individual logs in as a custodian.

Of course, each individual can equally log in in several categories.

Various information is reported in the IT application during registration of a client, transporter or custodian individual.

The information first comprises general information characterising the individuals themselves.

So a client individual can register his address, profession, usual needs in terms of delivery (destination, time, weight of the parcel, etc.), special preferences as to transport conditions (for example low levels of shocks or very fast transport), etc.

A transporter individual can register the routes he would normally take, the transport means he normally uses, the maximum weight of parcels he accepts to transport, his main qualities as transporter, etc. He can optionally mention his profession also.

A custodian individual, as such, can indicate his position, the number of packets he can store, the opening and closing times of his shop, the storage conditions (average storage temperature, security of the storage premises), etc.

The general information constitutes profiles of individuals, and is registered on the IT platform.

The information comprises also information reported in real time.

A client individual of course reports the characteristics of the next delivery he will need.

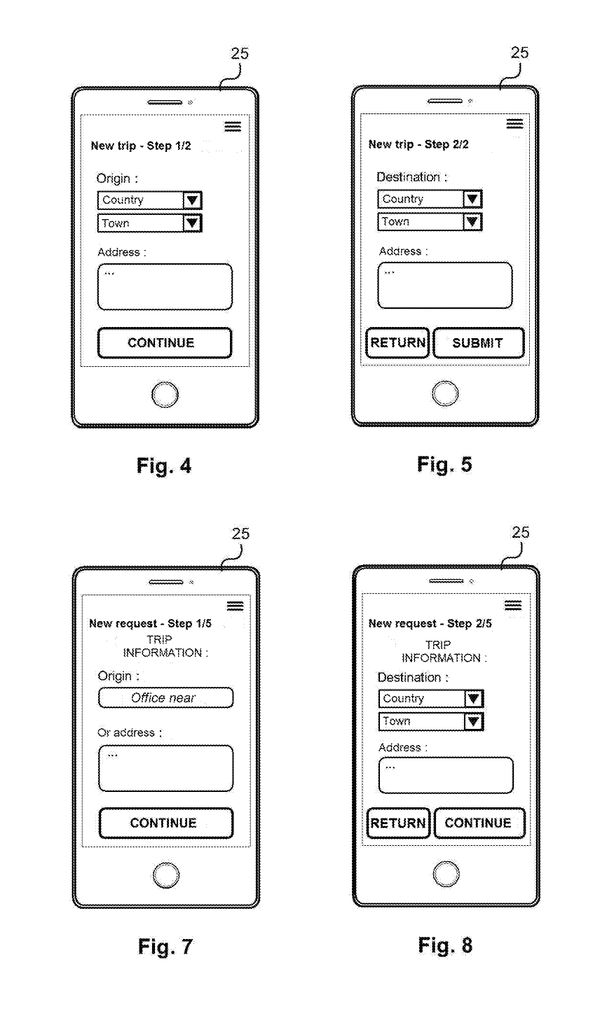

A transporter individual reports, via registration pages seen in FIGS. 4 and 5, the origin, dates and destination of the routes he planned for.

A custodian individual can for example indicate a particular closing timetable for his shop, or else a problem of packet 2 availability.

All this information recorded in real time is also recorded on the IT platform.

The general information and the information reported in real time are used for selecting the transporter individual or transporter individuals and the custodian individuals who will be involved in the transport of the item 1 between the position of origin and the position of destination, so as to optimise delivery performance. Optimisation is optimisation relative to the price of delivery and time of transport, but also relative to particular requests of a client individual. For example, a client individual can want his item to be transported by a transporter individual whose profile indicates that in general he is subjecting items he is transporting to low levels of shocks.

A first example of executing the transport management method according to the invention will now be described.

In reference to FIG. 6, a sending client individual 30 wants to send an item 1 to a recipient client individual 32. In this first example, apart from the sending client individual 30 and the recipient client individual 32, a first custodian individual 33, a second custodian individual 34 and a main transporter individual 35 are involved in the transport of the item 1.

The sending client individual 30 opens the IT application on an electronic device 25 in his possession. He is identified as a client individual, and accesses his personal space. This personal space comprises pages of a new delivery request.

The sending client individual 30 makes a new delivery request by first reporting the address of a position of origin where he is and where the item 1 to be transported is (FIG. 7).

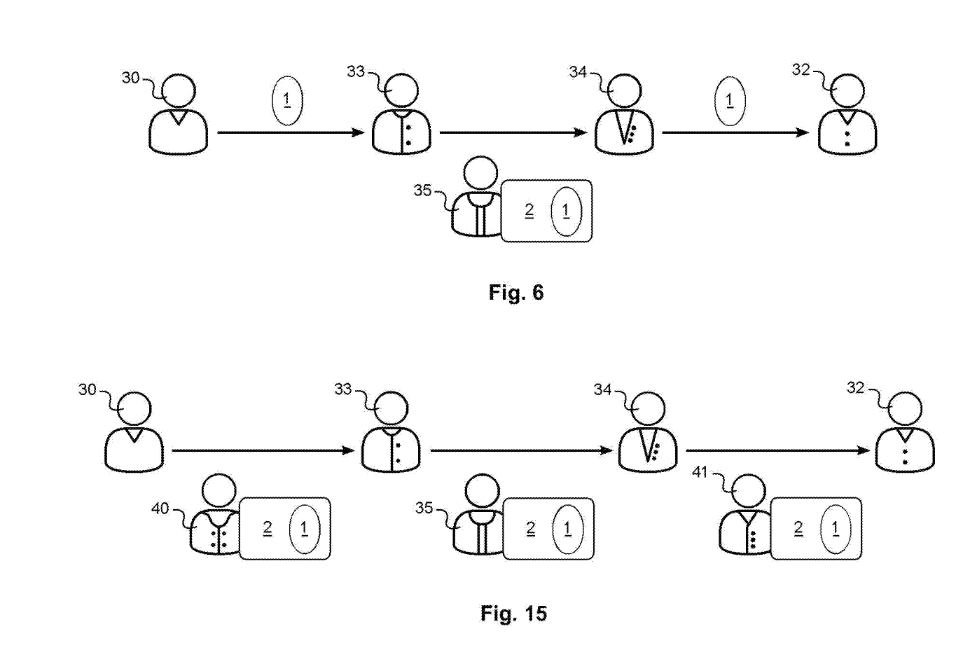

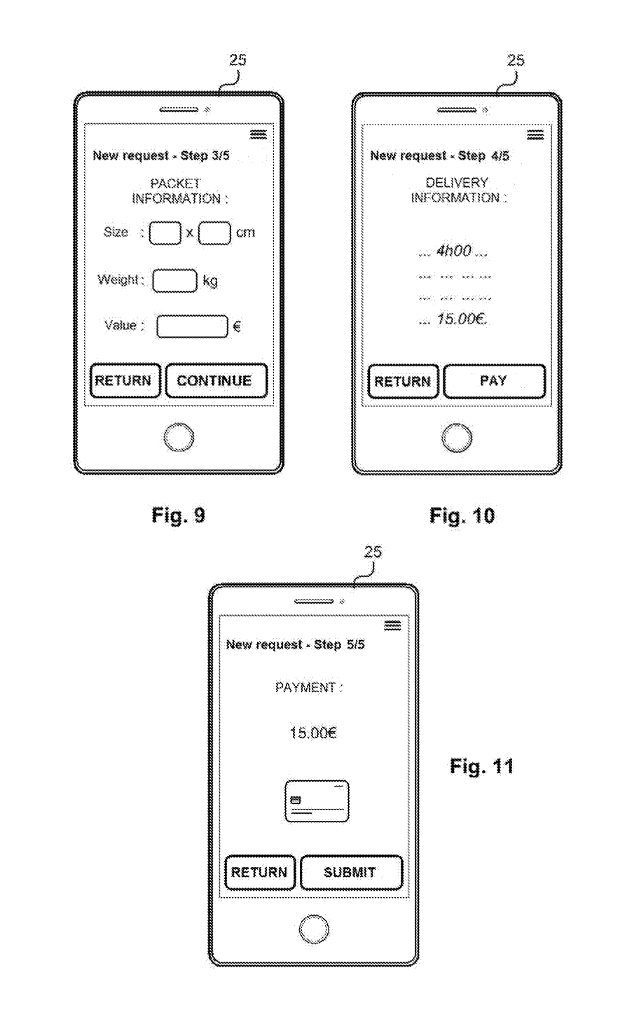

The sending client individual 30 is here in a town near Paris. He then reports the address of a destination position where the recipient client individual 32 of the item 1 is (FIG. 8). The recipient client individual 32 is here in a town near London. The sending client individual 30 then sends back the size, weight and value of the item 1 (FIG. 9).

The IT platform receives the delivery request of the item 1 sent by the sending client individual 30.

The IT platform calculates an optimised itinerary of the item 1 between the position of origin and the position of destination. The itinerary is here optimised so as to reduce the transport time and cost of delivery. The IT platform defines, as a function of the optimised itinerary, the position of the first custodian individual 33 and of the second custodian individual 34.

The IT platform indicates to the sending client individual 30, via the IT application, an estimated delivery time of the item 1 as well as a price corresponding to the delivery service of the item 1 (FIG. 10).

The sending client individual 30 pays the price of the delivery service (FIG. 11).

The IT platform indicates to the sending client individual 30, via the IT application, the position of the first custodian individual 33.

It is seen that an individual, likely to be a first custodian individual, cannot be designated as such if no packet 2 is available from this individual. If no packet 2 is available from an individual likely to be a first custodian individual, this individual must indicate this via the IT application. He could be designated as first custodian individual when he will have been provided with at least one packet 2.

Then the sending client 30 transports the item 1 to the position of the first custodian individual 33. Here the first custodian individual 33 is situated in a boutique of the Paris Gare du Nord train station.

The first custodian individual 33 accesses a packet 2 which is in the storage surface of the first custodian individual 33.

The first custodian individual 33 re-enters an identifier of the packet 2 in the IT application. This identifier is received by the IT platform which links the item 1 to the packet 2.

The sending client individual 30 and the first custodian individual 33 open the packet 2, introduce the item 1 into the packet 2, and reclose the packet 2.

The sending client individual 30 validates, via the IT application, the remise of the item 1 to the first custodian individual 33, which becomes responsible for the item 1 and of the packet 2.

The IT platform receives a first validation delivery datum.

The packet 2 is stored by the first custodian individual 33, in this case in the storage surface of the boutique of the first custodian individual 33.

The next step and the final destination of the packet 2 are stored in the memory 20 of the electric module 4 of the packet 2. The storage of the next step and of the final destination of the packet 2 is done via the electronic device 25 of the first custodian individual 33 and via the wireless proximity communications device of the packet 2. In this way, if any person carrying an electronic device on which the IT application is loaded discovers a packet 2 abandoned or lost, this person can interrogate the packet 2 and contributes to conveying the packet 2 on to its next step or to its final destination.

The next step and the final destination of the packet 2 correspond in this case to the position of the second custodian individual 34.

In parallel to what has just been described, the main transporter individual 35 opens the IT application on an electronic device in his possession. The IT application indicates to the main transporter individual 35 the presence of the packet 2 containing the item 1 from the first custodian individual 33.

The main transporter individual 35 is a transporter individual who travels the route by train between the Paris Gare du Nord train station and the Saint-Pancras train station, in London, starting out from the Paris Gare du Nord train station at a time close to (but after) of the moment when the item 1 is deposited with the first custodian individual 33. The choice of the main transporter individual 35 is made by the IT platform during calculation of the optimised itinerary.

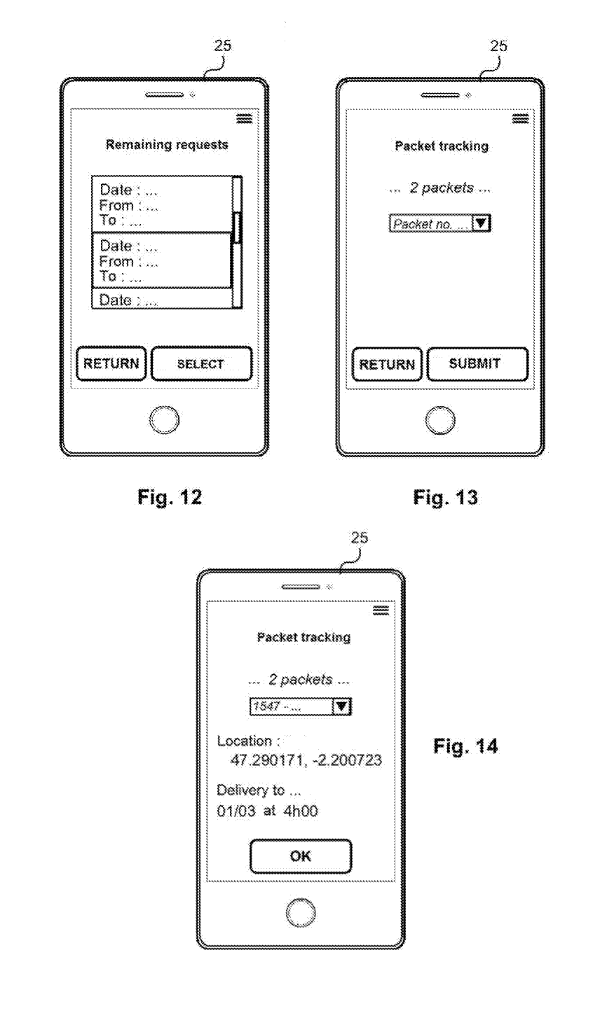

A transport request page (FIG. 12) is updated in the personal space of the IT application of the main transporter individual 35. The main transporter individual 35 accepts the transport request by selecting the route between the Paris Gare du Nord train station and the Saint-Pancras train station and obtains the delivery modalities.

The main transporter individual 35 goes to the first custodian individual 33. The first custodian individual 33 identifies the packet 2 from other stored packets. To access the packet 2 among the other stored packets, the first custodian individual 33 opens the IT application on an electronic device in his possession. The IT application connects the electronic device to the wireless proximity communications device of the packet 2. The electronic device of the first custodian individual 33 controls the microcontroller 18 of the electric module 4 of the packet 2 (via the wireless proximity communications device and therefore via the Bluetooth module 19) so that the packet 2 sends a sound signal via the buzzer 6, or else so that the packet 2 sends a visual signal via the LED 7, which facilitates recognition of the packet 2 in the storage surface of the first custodian individual 33.

The first custodian individual 33 validates on the IT application the correct handing over of the packet 2 to the main transporter individual 35 who becomes responsible for the item 1 and of the packet 2.

The IT platform receives a second validation delivery datum.

The main transporter individual 35 travels the route between the Paris Gare du Nord train station and the Saint-Pancras train station by train, transporting the packet 2 containing the item 1.

Along this route, the electronic device of the main transporter individual 35 is connected to the wireless proximity communications device of the packet 2.

By way of this connexion, the electronic device of the main transporter individual 35 and the packet 2, but also the IT application and the IT platform constitute an intelligent system within which data are exchanged. A large part of the intelligence of the intelligent system here comes from the electronic device, the IT application and the IT platform. The packet 2 is a mainly passive element of the intelligent system, which sends data when it is activated and interrogated by the sending client individual 30 and by the recipient client individual 32, via the IT application and the electronic device of the main transporter individual 35.

The sending client individual 30 and the recipient client individual 32 can, in real time, interrogate the packet 2 and request sending by the packet 2 of a certain number of data representative of the situation of the packet 2 and of the item 1

The sending client individual 30 and the recipient client individual 32 select for this, on a first tracking page, the packet 2 for which they want to receive data (FIG. 13).

The data sent first comprise data sent by the packet 2 via the wireless proximity communications device of the packet 2.

The data sent by the packet 2 comprise measuring data taken by sensors integrated into the packet 2. The measuring data comprise measuring data of weight of the item 1, measuring data of a temperature inside the packet 2, shock measuring data, humidity measuring data.

The data sent by the packet 2 also comprise images of the interior of the packet 2.

The data sent by the packet 2 comprise also an alarm signal produced by the detection means 14 and signalling opening of the packet 2. The alarm signal is sent to the sending client individual 30 and to the recipient client individual 32.

The data sent also comprise geolocation data of the electronic device of the main transporter individual 35 and therefore of the packet 2.

The data sent finally comprise an estimation of a delivery time of the item 1.

These data are accessible on a second tracking page (FIG. 14).

When the main transporter individual 35 arrives at the Saint-Pancras train station, the main transporter individual 35 goes to a restaurant of the Saint-Pancras train station where the second custodian individual 34 is waiting.

The main transporter individual 35 hands over the packet 2 to the second custodian individual 34 and validates on the IT application the correct handing over of the item 1 to the second custodian individual 34 who becomes responsible for the item 1 and the packet 2.

The IT platform receives a third validation delivery datum.

The item 1 is taken out of the packet 2 and is stored in a storage surface of the restaurant of the second custodian individual 34.

The recipient client individual 32 is informed of the presence of the item 1 in the restaurant of the second custodian individual 34 via notification on the personal space of the recipient client individual 32 in the IT application.

The recipient client individual 32 goes to the second custodian individual 34. The second custodian individual 34 identifies the packet 2 (optionally via the buzzer 6 and the LED 7) and hands it over to the recipient client individual 32.

The recipient client individual 32 and the second custodian individual 34 take the item 1 out of the packet 2. The item 1 is handed over to the recipient client individual 32. The second custodian individual 34 validates on the IT application the correct handing over of the item 1 to the recipient client individual 32 who becomes responsible for the item 1.

The IT platform receives a fourth validation delivery datum.

The item 1 is transported by the recipient client individual to the destination position of the item where the recipient client individual 32 of the item 1 is on completion of transport of the item 1 and its delivery.

It is noted that if any accident occurs during transport of the item, the IT platform calculates a new optimised itinerary to let the item 1 arrive at his destination position. Such an accident is for example the loss of a packet 2, found later, or else a vehicle accident preventing the main transporter individual 35 from arriving at the position of the second custodian individual 34, or else a fire preventing the first custodian individual 33 from storing the packet 2, etc.

A second example of executing the transport management method according to the invention will now be described.

In reference to FIG. 15, a sending client individual 30 wants to send an item 1 to a recipient client individual 32. In this second example, apart from the sending client individual 30 and the recipient client individual 32, a first custodian individual 33, a second custodian individual 34, a main transporter individual 35, a first secondary transporter individual 40 and a second secondary transporter individual 41 are involved in the transport of the item 1.

The IT platform again receives a first validation delivery datum when the packet 2 containing the item is handed over to the first custodian individual 33, a second validation delivery datum when the packet 2 is handed over to the main transporter individual 35 by the first custodian individual 33, a third validation delivery datum when the packet 2 is handed over to the second custodian individual 34 by the main transporter individual 35, and a fourth validation delivery datum when the item 1 is handed over to the recipient client individual 32.

The second example differs especially from the preceding one in that, in the second example, the first secondary transporter individual 40 (and not the sending client individual 30) brings the item 1 (in a packet 2) to the first custodian individual 33, and in that the second secondary transporter individual 41 (and not the recipient client individual 32) brings the item 1 to the recipient client individual 32.

So the first secondary transporter individual 40 armed with a packet 2 goes to the sending client individual 30 when the latter has submitted a new delivery request of an item 1.

The sending client individual 30 and the first secondary transporter individual 40 open the packet 2, introduce the item 1 to the packet 2, and reclose the packet 2.

The sending client individual 30 validates on the IT application the correct handing over of the item 1 to the first secondary transporter individual 40 who becomes responsible for the item 1 and the packet 2.

The IT platform receives a fifth validation delivery datum.

The first secondary transporter individual 40 goes to the first custodian individual 33 and passes him the packet 2. The first secondary transporter individual 40 validates on the IT application the correct handing over of the item 1 and of the packet 2 to the first custodian individual 33. The first custodian individual 33 stores the packet 2 and becomes responsible for the item 1 and of the packet 2.

The main transporter individual 35 travels the route between the Paris Gare du Nord train station and the Saint-Pancras train station by train. When he arrives at the Saint-Pancras train station he goes to the first custodian individual 33 and recovers the packet 2. The first custodian individual 33 validates on the IT application the correct handing over of the item 1 and of the packet 2 to the main transporter individual 35. The main transporter individual 35 becomes responsible for the item 1 and of the packet 2.

The main transporter individual 35 goes to the second custodian individual 34 and passes him the packet 2. The main transporter individual 35 validates on the IT application the correct handing over of the item 1 and of the packet 2 to the second custodian individual 34. The second custodian individual 34 becomes responsible for the item 1 and of the packet 2.

The second secondary transporter individual 41 goes to the second custodian individual 34 who passes him the packet 2. The second custodian individual 34 validates on the IT application the correct handing over of the item 1 and of the packet 2 to the second secondary transporter individual 41. The second secondary transporter individual 41 becomes responsible for the item 1 and the packet 2.

The platform receives a sixth validation delivery datum.

The second secondary transporter individual 41 goes to the recipient client individual 32 and passes him the packet 1.

The second secondary transporter individual 41 and the recipient client individual 32 open the packet 2. The recipient client individual 32 recovers the item 1. The second secondary transporter individual 41 validates on the IT application the correct handing over of the item 1 and of the packet 2 to the recipient client individual 32.

The packet 2 is either kept by the recipient client individual 32 for next delivery, or recovered by the second secondary transporter individual 41 who keeps the packet 2 for next delivery or else who takes it back to the second custodian individual 34.

Of course, the invention is not limited to the embodiment as described but covers any variant in the scope of the invention such as defined by the claims.

The client individuals (sender or receiver) mentioned here are not necessarily veritable <<clients>> who pay for delivery service, but can be individuals in possession of the packet before transport and on receipt of the packet, who are acting on behalf of a veritable client (who pays for the delivery service).

It is also pointed out here that it is the sending client individual who is at the origin of delivery, but it could also be the recipient client individual.

The components equipping the packet can of course be different to those presented here. In this way, the packet could contain an accelerometer, a geolocation sensor, a vibration sensor, etc. Similarly, the camera could be arranged to film the exterior of the packet, or else the packet could be equipped with photo equipment taking photos of the interior or exterior of the packet. The electric card module as such can have different architecture and comprise different components (for example, an FPGA in place of or in addition to the microcontroller, or else in the wireless proximity communications device, a WIFI or NFC module in place of the Bluetooth module).

The use of resources (individuals, packets, electronic devices, etc.) can of course be different to what has been described in the first example and the second example of executing the transport method according to the invention. So it is possible for example to imagine that, in the first example, the sending client individual is himself in possession of a packet in which he places the item to be delivered, or else the recipient client individual also recovers the packet with the item from the second custodian individual and keeps the packet for another delivery.

It has also been described here that exchanges of data take place between the second electronic device of the main transporter and the packet. It can be fully expected that data are also exchanged between the packet and the electronic device of the sending client individual, the recipient client individual, the first secondary transporter individual, the second secondary transporter individual, the first custodian individual, the second custodian individual, or else any other individual involved in transport of the item.

1. A method for managing transport of an item executed by an IT platform and comprising the steps of:
receiving a delivery request of an item sent by a sending client individual;
calculating an optimised itinerary of the item between a position of the sending client individual and a position of a recipient client individual;
defining the position of a first custodian individual and a second custodian individual;
linking the item to a packet in which the item is introduced, the packet comprising an electric module comprising a wireless proximity communications device;
receiving a first validation delivery datum when the item or the packet containing the item is handed over to the first custodian individual;
receiving a second validation delivery datum when the packet is handed over to a main transporter individual by the first custodian individual;
receiving a third validation delivery datum when the packet is handed over to the second custodian individual by the main transporter individual;
receiving a fourth validation delivery datum when the item or the packet containing the item is handed over to the recipient client individual.

2. The transport management method according to claim 1, wherein the IT platform runs an IT application used by electronic devices to send the delivery request, the first validation delivery datum, the second validation delivery datum, the third validation delivery datum and the fourth validation delivery datum.

3. The transport management method according to claim 2, wherein the first custodian individual, the second custodian individual and the main transporter individual are selected as a function of information previously reported via the IT application.

4. The transport management method according to claim 1, further comprising the step of sending to the packet via the wireless proximity communications device of the packet a next step and/or a final destination of the packet, the next step and/or the final destination of the packet being stored in a memory of the electric module of the packet.

5. The transport management method according to claim 1, comprising the step of receiving a fifth validation delivery datum when the item or the packet containing the item is handed over to a first secondary transporter individual by the sending client individual, the first secondary transporter individual being in charge of bringing the item or the packet containing the item to the first custodian individual.

6. The transport management method according to claim 1, comprising the step of receiving a sixth validation delivery datum when the item or the packet containing the item is handed over to a second secondary transporter individual by the second custodian individual, the second secondary transporter individual being in charge of bringing the item or the packet containing the item to the recipient client individual.

7. The transport management method according to claim 1, comprising the step of calculating a new optimised itinerary in case of accident occurring during transport of the item.

8. The transport management method according to claim 1, comprising the step of receiving data sent via an electronic device connected to the wireless proximity communications device of the packet.

9. The transport management method according to claim 8, wherein the data sent comprise data sent by the packet via the wireless proximity communications device of the packet.

10. The transport management method according to claim 9, wherein the data sent by the packet comprise measuring data taken by sensors integrated into the packet.

11. The transport management method according to claim 10, wherein the measuring data comprise measuring data of a weight of the item and/or measuring data of a temperature and/or measuring data of shocks and/or humidity measuring data.

12. The transport management method according to claim 9, wherein the data sent by the packet comprise images of the interior and/or of the exterior of the packet.

13. The transport management method according to claim 9, wherein the data sent by the packet comprise an alarm signal signalling opening of the packet.

14. The transport management method according to claim 8, wherein the data sent comprise geolocation data of the electronic device and therefore of the packet.
